(19) United States
(12) Patent Application Publication
(10) Pub. No.: US 2026/0236519 A1
(43) Pub. Date: Aug. 13, 2026

(54) DOUBLY ROBUST SYSTEMS AND METHODS FOR HALLUCINATION- RESISTANT DATA SUMMARIZATION

(71) Applicant: Capital One Services, LLC, McLean, VA (US)

(72) Inventor: Ayaz MEHMANI, Teaneck, NJ (US)

(73) Assignee: Capital One Services, LLC, McLean, VA (US)

(21) Appl. No.: 19/051,265

(22) Filed: Feb. 12, 2025

(51) Int. Cl. G06F 16/34; G06F 16/334

(52) U.S. Cl. CPC G06F 16/345; G06F 16/3347

(57) ABSTRACT

A system may include, as part of a doubly robust large language model (LLM) architecture for data summarization, a pre-trained LLM in addition to first and second fine-tuned LLMs derived from the pre-trained LLM and fine-tuned with training datasets collected over different time periods. In response to receiving a request to summarize a dataset, the dataset is provided as input to each of the LLMs to obtain, as output, a first summary, a second summary, and a third summary generated by the pre-trained LLM, first fine-tuned LLM, and second fine-tuned LLM, respectively. Each of the second and third summary may be compared to the first summary relative to a similarity threshold to determine whether a hallucination associated with the first or second fine-tuned LLM is indicated and, based on the determination, select one of the second or third summary as a response to the request or halt the data summarization.

### TECHNICAL FIELD

Various embodiments of this disclosure relate generally to techniques for utilizing large language models (LLMs) for data summarization and, more particularly, to doubly robust systems and methods for hallucination-resistant data summarization.

### BACKGROUND

Call logs of recorded conversations between customers and entity agents may provide valuable and extensive information to the entity regarding customer sentiment, competitive landscape, or general market dynamics. Speech-to-text transcriptions generated from audio or video recordings of the calls may be of poor quality (e.g., corrupt). For example, these transcriptions may include missing or inaccurate symbols, characters, words, or phrases that may significantly impact semantics or intents derivable from the transcript for use in downstream evaluation processes.

Therefore, large language models (LLMs) that are pre-trained to reconstruct (e.g., to resolve) such corrupt data have been increasingly utilized to generate call log summaries for subsequent evaluation or analysis. However, LLMs applied to summarize data may hallucinate causing summaries to be generated that are inaccurate, irrelevant or nonsensical, despite being presented by the LLMs as factual with confidence. Additionally, fine-tuning of pre-trained LLMs for data summarization applications is often limited to only one of recency or continuous fine-tuning.

This disclosure is directed to addressing the above-referenced challenges, among other challenges. The background description provided herein is for the purpose of generally presenting the context of the disclosure. Unless otherwise indicated herein, the materials described in this section are not prior art to the claims in this application and are not admitted to be prior art, or suggestions of the prior art, by inclusion in this section.

### SUMMARY OF THE DISCLOSURE

According to certain aspects of the disclosure, doubly robust systems and methods are disclosed for large language model (LLM)-based data summarization. These doubly robust systems and methods may enable for model hallucination monitoring and model decisioning to determine which model's generated data summary to output responsive to a request.

For instance, an example system may include: a pre-trained LLM configured to generate a summary of data received as input; a first fine-tuned LLM derived from the pre-trained LLM and fine-tuned with a plurality of sets of data received over a first period of time; a second fine-tuned LLM derived from the pre-trained LLM and fine-tuned with a subset of the plurality of sets of data received over a second period of time shorter than the first period of time; and a computing system. The computing system may include at least one memory storing instructions, and at least one processor operatively connected to the at least one memory and configured to execute the instructions to perform operations. The operations may include: receiving a request to summarize a new set of data; providing the new set of data, as input, to each of the pre-trained LLM, the first fine-tuned LLM, and the second fine-tuned LLM to obtain, as output, a first summary of the new set of data generated by the pre-trained LLM, a second summary of the new set of data generated by the first fine-tuned LLM, and a third summary of the new set of data generated by the second fine-tuned LLM; and comparing each of the second summary and the third summary to the first summary relative to a similarity threshold. When, based on the comparing, a similarity between the first summary and each of the second summary and the third summary meet the similarity threshold, the operations may further include selecting one of the second summary or the third summary to provide as a response to the request based on one or more predefined criteria. When, based on the comparing, a similarity between the first summary and at least one of the second summary or the third summary fails to meet the similarity threshold, the failure being indicative of a hallucination associated with the at least one of the first fine-tuned LLM or the second fine-tuned LLM, respectively, the operations may further include initiating a further fine-tuning of the at least one of the first fine-tuned LLM or the second fine-tuned LLM to mitigate the hallucination.

An example method performed by a computing system for data summarization may include: receiving a request to summarize a dataset; providing the dataset, as input, to each model of a LLM architecture executed by the computing system, the LLM architecture including: a pre-trained LLM configured to generate a summary of input data, a first fine-tuned LLM derived from the pre-trained LLM and fine-tuned with a plurality of training datasets received over a first period of time, and a second fine-tuned LLM derived from the pre-trained LLM and fine-tuned with a subset of the plurality of training datasets received over a second period of time shorter than the first period of time; receiving, as output, a summary of the dataset from each model of the LLM architecture, including a first summary generated by the pre-trained LLM, a second summary generated by the first fine-tuned LLM, and a third summary generated by the second fine-tuned LLM; and comparing each of the second summary and the third summary to the first summary relative to a first similarity threshold. The method may further include: determining that a similarity of each of the second summary and the third summary to the first summary meets the first similarity threshold, the meeting of the first similarity threshold being indicative of a lack of hallucination associated with the first fine-tuned LLM and the second fine-tuned LLM; comparing the second summary to the third summary relative to a second similarity threshold; and selecting one of the second summary or the third summary to provide as a response to the request based on the comparing and one or more predefined criteria.

Another example method performed by a computing system for data summarization may include: receiving a request to summarize a dataset; providing the dataset, as input, to each model of a LLM architecture executed by the computing system, the LLM architecture including: a pre-trained LLM configured to generate a summary of input data, a first fine-tuned LLM derived from the pre-trained LLM and fine-tuned with a plurality of training datasets received over a first period of time, and a second fine-tuned LLM derived from the pre-trained LLM and fine-tuned with a subset of the plurality of training datasets received over a second period of time shorter than the first period of time; receiving, as output, a summary of the dataset from each model of the LLM architecture, including a first summary generated by the pre-trained LLM, a second summary generated by the first fine-tuned LLM, and a third summary generated by the second fine-tuned LLM; and comparing each of the second summary and the third summary to the first summary relative to a first similarity threshold. The method may further include determining, based on the comparing, that a similarity between the first summary and at least one of the second summary or the third summary fails to meet a similarity threshold indicative of a hallucination associated with the at least one of the first fine-tuned LLM or the second fine-tuned LLM, respectively; and initiating a further fine-tuning of the at least one of the first fine-tuned LLM or the second fine-tuned LLM to mitigate the hallucination.

### BRIEF DESCRIPTION OF THE DRAWINGS

The accompanying drawings, which are incorporated in and constitute a part of this specification, illustrate various exemplary embodiments and together with the description, serve to explain the principles of the disclosed embodiments.

FIG. 1 depicts an exemplary environment for large language model (LLM)-based data summarization, according to certain embodiments.

FIG. 2 depicts a flowchart of an exemplary process for building a doubly robust LLM architecture, according to certain embodiments.

FIG. 3 depicts a block diagram of exemplary fine-tuning processes performed to build the doubly robust LLM architecture, according to certain embodiments.

FIG. 4 depicts a conceptual diagram of input data provided to the doubly robust LLM architecture during training and deployment phases, according to certain embodiments.

FIG. 5 depicts a flowchart of an exemplary process for data summarization using the doubly robust LLM architecture, according to certain embodiments.

FIG. 6 depicts a block diagram of exemplary model hallucination monitoring and model decisioning processes performed as part of the data summarization, according to certain embodiments.

FIG. 7 depicts an example of a computer, according to certain embodiments.

### DETAILED DESCRIPTION OF EMBODIMENTS

According to certain aspects of the disclosure, data summarization systems and method are disclosed. As will be discussed in more detail below, in various embodiments, systems and methods are described for implementing a doubly robust large language model (LLM) architecture to provide hallucination-resistant data summarization.

As briefly discussed above, call logs of recorded conversations between customers and entity agents may provide valuable and extensive information to an entity regarding customer sentiment, competitive landscape, or general market dynamics. Speech-to-text transcriptions generated from audio or video recordings of the calls may be of poor quality (e.g., corrupt). For example, these transcriptions may include missing or inaccurate symbols, characters, words, or phrases that may significantly impact semantics or intents derivable from the transcript for use in downstream evaluation processes. Therefore, large language models (LLMs) that are pre-trained to reconstruct (e.g., to resolve) such corrupt data have been increasingly utilized to generate call log summaries for subsequent evaluation or analysis.

However, LLMs applied to summarize data may hallucinate causing summaries to be generated that are inaccurate, irrelevant or nonsensical, despite being presented by the LLMs as factual with confidence. Given the passive format of data summarization techniques, as opposed to user-interactive ones such as online chat bots, detecting hallucination in a data summarization environment is particularly challenging. In the call log context, a sizable number of calls may be recorded and summarized. Therefore, a human-in-the-loop system, where agents manually check or review the LLM-generated call summaries may simply be unfeasible.

Additionally, fine-tuning of pre-trained LLMs for data summarization applications is not trivial, and is often limited to only one of recency or continuous fine-tuning. Leveraging only recent call datasets when fine-tuning the pre-trained LLM risks anchoring the model to recent trends (e.g., trending or hot conversation topics). On the other hand, continuous fine-tuning of the pre-trained LLM using call datasets spanning back a longer period of time reduces the model's sensitivity to the more recent trends.

The present disclosure solves these problems or other problems described above or elsewhere in the present disclosure, namely by implementing a doubly-robust LLM architecture that monitors for and proactively mitigates hallucinations, while also leveraging both recency and continuous fine-tuning. The doubly-robust LLM architecture includes three models: a first model that is a pre-trained LLM, a second model that is a continuously fine-tuned LLM derived from the pre-trained LLM, and a third model that is recency fine-tuned LLM derived from the pre-trained LLM. When a new dataset to be summarized is received, the new dataset may be provided as input to each of the three models to obtain, as output, a summary generated by each model.

An initial summary comparison may be performed to monitor for model hallucination. For example, second and third summaries generated by the second and third models, respectively, may each be compared to the first summary generated by the first model using similarity quantification methods to determine whether the second or third models may be hallucinating or otherwise degrading in quality. If so, further fine-tuning of the second or third models may be initiated as a mitigating action. For example, if based on the comparison, the second summary or third summary shows anomalously increased differences from the first summary, the second model or third model may be hallucinating. Due to summary inaccuracies that result from hallucination, if both the second and third models are determined to be hallucinating, the data summarization may be temporarily halted as the models are being further fine-tuned. However, if only one of the second or third models is determined to be hallucinating, the hallucinating model may be further fine-tuned, while a respective summary of the non-hallucinating model may be provided as the output summary for the new dataset.

If neither of the second or third models are determined to be hallucinating or otherwise degrading in quality, a subsequent summary comparison may be performed as part of a model selection process that directs which model's summary will be provided as the output summary for the new dataset. For example, in the subsequent summary comparison, the second and third summaries generated by the second and third models, respectively, may be compared to one another using similarity quantification methods. Generally, a diversity associated with the second model may be preferred and thus the second model is selected, particularly when the compared second and third summaries meet a similarity threshold. However, in some examples, if the second and third summaries are markedly different from one another (e.g., do not meet the similarity threshold), predefined criteria, such as business rules or logic, may alternatively indicate a preference of a recency associated with the third model, and the third model may instead be selected.

Reference to any particular activity, such as call log-specific data summarization, is provided in this disclosure only for convenience and is not intended to limit the disclosure. A person of ordinary skill in the art would recognize that the concepts underlying the disclosed systems and methods may be utilized in any suitable data summarization activity or task. The disclosure may be understood with reference to the following description and the appended drawings, wherein like elements are referred to with the same reference numerals.

The terminology used below may be interpreted in its broadest reasonable manner, even though it is being used in conjunction with a detailed description of certain specific examples of the present disclosure. Indeed, certain terms may even be emphasized below; however, any terminology intended to be interpreted in any restricted manner will be overtly and specifically defined as such in this Detailed Description section. Both the foregoing general description and the following detailed description are exemplary and explanatory only and are not restrictive of the features, as claimed.

In this disclosure, the term “based on” may convey “based at least in part on.” The singular forms “a,” “an,” and “the” may include plural referents unless the context dictates otherwise. The term “exemplary” may be used in the sense of “example” rather than “ideal.” The terms “comprises,” “comprising,” “includes,” “including,” or other variations thereof, may convey a non-exclusive inclusion such that a process, method, or product that comprises a list of elements does not necessarily include only those elements, but may include other elements not expressly listed or inherent to such a process, method, article, or apparatus. The term “or” may be interpreted disjunctively, such that “at least one of A or B” includes, (A), (B), (A and A), (A and B), etc. Similarly, the term “or” is intended to mean “and/or,” unless explicitly stated otherwise. “And/or” may convey all permutations, combinations, subcombinations, and individual instances of items or terms included within a list of the items or terms. Relative terms, such as, “substantially” and “generally,” may be used to indicate a possible variation of ±10% of a stated or understood value.

Presented below are various aspects of machine learning techniques that may be adapted for data summarization. As will be discussed in more detail below, the machine learning techniques may include one or more aspects according to this disclosure, e.g., a particular selection of training data, a particular training or fine-tuning process for each machine learning model, operation of each machine learning model in conjunction with particular data, modification of such particular data by each machine learning model, etc., or other aspects that may be apparent to one of ordinary skill in the art based on this disclosure.

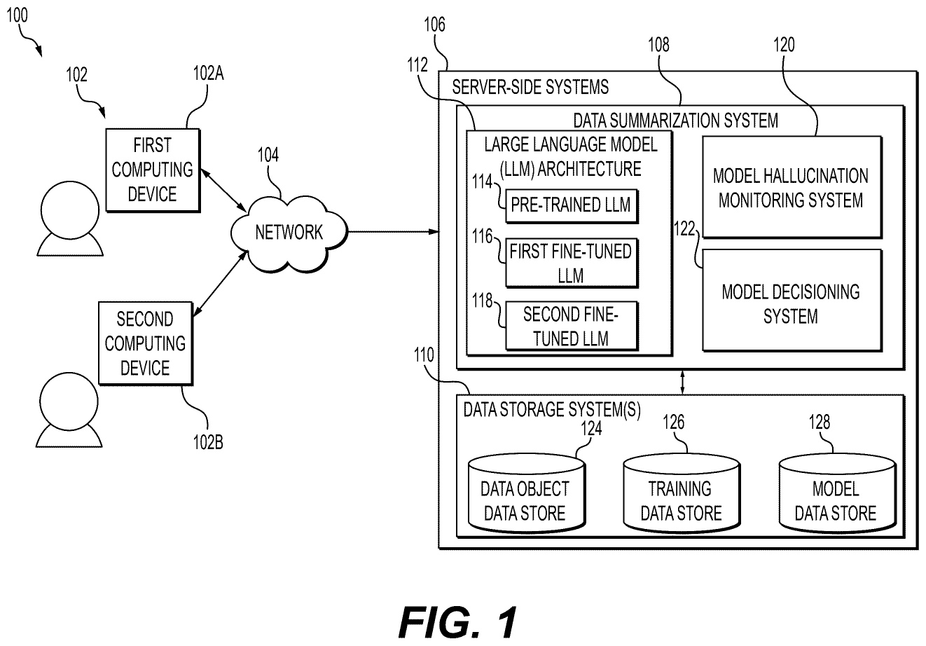

FIG. 1 depicts an exemplary environment 100 for LLM-based data summarization, according to certain embodiments, and which may be used with the techniques presented herein. A plurality of computing devices 102 may communicate with one or more of the other components of the environment 100 across electronic network 104, including one or more server-side systems 106 associated with a provider, discussed below.

The provider may generally encompass an entity or person involved in providing, selling, or renting items to persons, as well as an agent or intermediary of such an entity or person. An “item” may generally encompass a good, service, or the like having ownership or other rights that may be transferred. Herein the item provided by the provider may be data summarization services. As used herein, terms like “consumer” or “subscriber” may generally encompass any person or entity that may consume the data summarization services from the provider (e.g., through an application). The term “application” may be used interchangeably with other terms like “program,” or the like, and generally encompasses software that is configured to interact with, modify, override, supplement, or operate in conjunction with other software.

The network 104 over which the one or more components of the environment 100 communicate may include one or more wired or wireless networks, such as a wide area network (“WAN”), a local area network (“LAN”), personal area network (“PAN”), a cellular network (e.g., a 3G network, a 4G network, a 5G network, etc.) or the like. In some embodiments, the network 104 includes the Internet, and information and data provided between various systems occurs online. “Online” may mean connecting to or accessing source data or information from a location remote from other devices or networks coupled to the Internet. Alternatively, “online” may refer to connecting or accessing an electronic network (wired or wireless) via a mobile communications network or device. The Internet is a worldwide system of computer networks—a network of networks in which a party at one computer or other device connected to the network can obtain information from any other computer and communicate with parties of other computers or devices. The most widely used part of the Internet is the World Wide Web (often-abbreviated “WWW” or called “the Web”). A “website page” or “web page” generally encompasses a location, data store, or the like that is, for example, hosted or operated by a computer system so as to be accessible online, and that may include data configured to cause a program such as a browser to perform operations such as send, receive, or process data, generate a visual display or an interactive interface, or the like. The computing devices 102 and one or more of the server-side systems 106 may be connected via the network 104, using one or more standard communication protocols. The computing devices 102 and the one or more of the server-side systems 106 may transmit and receive communications from each other across the network 104, as discussed in more detail below.

The server-side systems 106 may include a data summarization system 108 or one or more data storage system(s) 110, among other systems. In some embodiments, the data summarization system 108 and at least one of the data storage system(s) 110 may be associated with a common entity, e.g., the provider, or the like. In such embodiments, the data summarization system 108 and the at least one of the data storage system(s) 110 may be part of a cloud service computer system (e.g., in a data center). In other embodiments, one or more of the components of the environment 100 may be associated with a different entity than one another. For example, one or more of the data storage system(s) 110 may be associated with a third party that provides data storage services to the provider or associated with the entity that is subscribing to or consuming the data summarization services of the provider. The systems and devices of the environment 100 may communicate in any arrangement. As will be discussed herein, systems devices of the environment 100 may communicate in order to enable data summarization, among other activities.

The computing devices 102 may be configured to enable access to or interaction with other systems in the environment 100. For example, the computing devices 102 may be a computer system such as, for example, a desktop computer, a laptop computer, a tablet, a smart cellular phone, a smart watch or other electronic wearable, etc. In some embodiments, the computing devices 102 may include one or more electronic application(s), e.g., a program, plugin, browser extension, etc., installed on a memory of the computing devices 102. The electronic application(s) may include one or more of system control software, system monitoring software, software development tools, etc. In some embodiments, the electronic application(s) may be associated with one or more of the other components in the environment 100. For example, the computing devices 102 may include an application associated with the data summarization system 108 or components thereof. In some examples, the application may be a thick client application that is installed locally on the computing devices 102 (e.g., a desktop application or mobile application). In other examples, the application may be a thin client application (e.g., a web application) that is rendered via the browser launched on the computing devices 102.

Additionally, one or more components of the computing devices 102 may generate, or may cause to be generated, one or more graphic user interfaces (GUIs) based on instructions/information stored in the memory, instructions/information received from the other systems in the environment 100, or the like and may cause the GUIs to be displayed via a display of the computing devices 102. The GUIs may be, e.g., browser user interfaces or application interfaces and may include text, input text boxes, selection controls, or the like. The display may include a touch screen or a display with other input systems (e.g., a mouse, keyboard, etc.) for the user of the computing devices 102 to control the functions thereof.

As shown in FIG. 1, the computing devices 102 may include a first computing device 102A and a second computing device 102B. The first computing device 102A may be associated with a user (e.g., a subscriber) consuming the data summarization services provided by the data summarization system 108 (e.g., a subscriber computing device). The second computing device 102B may be associated with an administrator, model developer, or other similar monitoring team member associated with the provider (or a third party providing model building and maintaining services to the provider) to monitor model-related aspects of the data summarization system 108, as described in more detail below.

The data summarization system 108 may include one or more server devices (or other similar computing devices) for executing data summarization services. In some examples, and as illustrated in FIG. 1, the data summarization system 108 may include a plurality of sub-systems or components, such as a LLM architecture 112, a model hallucination monitoring system 120, and a model decisioning system 122. Each of these sub-systems or components may be configured to perform a different subset of tasks to execute the data summarization services, and each may be executable independently or in conjunction with one another. In other examples, one or more of these sub-systems or components may be external systems providing the services as third-party services to the data summarization system 108. Example data summarization services may include, but are not limited to, tasks associated with: receiving a data summary request, generating multiple data summaries for the request using the LLM architecture 112, monitoring for model hallucination by comparing the data summaries generated, mitigating model hallucination if detected, or selecting an output data summary from the multiple data summaries to provide in response to the request.

In some embodiments, the data summarization system 108 may one or more of generate, store, train, or use a plurality of machine learning models. Specifically, the machine learning models may be LLMs forming the LLM architecture 112. The data summarization system 108 may include the LLM architecture 112, or instructions associated with each of the models of the LLM architecture 112, e.g., instructions for generating, training (e.g., fine-tuning), or using one or more of the models, etc. In other embodiments, a system or device other than the data summarization system 108 may be used to generate or train (e.g., fine-tune) one or more of the models. Resulting trained model(s) may then be provided to the data summarization system 108 for storage and subsequent deployment.

Generally, each model includes a set of variables, e.g., nodes, neurons, filters, etc., that are tuned, e.g., weighted or biased, to different values via the application of training datasets provided as input to the respective model. In some examples, the models may be trained using unsupervised learning processes that do not include pre-assigned or annotated labels or scores to aid the learning process. Rather, unsupervised learning processes may include clustering, classification, or the like to identify naturally occurring patterns in the training datasets. In other examples, supervised or semi-supervised learning processes may be implemented.

In some examples, one or more of the models may be retrained periodically. In other examples, and as described in detail below, one or more of the models may be retrained in response to detecting the model is hallucinating post-deployment. Once trained, the models may be stored and subsequently deployed by the data summarization system 108 in response to receiving a data summary request.

As described in more detail below, the models of the LLM architecture 112 may include a pre-trained LLM 114, a first fine-tuned LLM 116, and a second fine-tuned LLM 118. The pre-trained LLM 114 may be any pre-trained foundational model, also referred to herein as a baseline model. Each of the first fine-tuned LLM 116 and the second fine-tuned LLM 118 may be derived from the pre-trained LLM 114. Based on time-related characteristics associated with the datasets used to train or fine-tune these models, the first fine-tuned LLM 116 may also be referred to as a current model that is continuously fine-tuned using datasets received over a first period of time, and the second fine-tuned LLM 118 may also be referred to as a recent model that is fine-tuned using a smaller subset of more recent datasets received over a second period of time.

While one LLM architecture 112 is described herein, in other examples, the data summarization system 108 may include a plurality of LLM architectures 112 that are each trained/or fine-tuned using datasets that are specific to one or more topic areas, and thus configured to generate data summaries for those specific topic areas.

The data storage system(s) 110 may include a server system or computer-readable memory such as a hard drive, flash drive, disk, etc. In some embodiments, the data storage system(s) 110 include or interact with an application programming interface for exchanging data to other systems, e.g., one or more of the other components of the environment, such as at least the data summarization system 108 or the sub-systems or components thereof. The data storage system(s) 110 may include or act as a repository or source for various types of data. For example, the data storage system(s) 110 may include a plurality of data stores, including a data object data store 124, a training data store 126, or a model data store 128, among other data stores.

The data object data store 124 may include data to be summarized. In some examples, the data object data store 124 may be associated with a subscribing entity whose data is to be summarized. In other examples, the data object data store 124 may be associated with the provider of the data summarization services, where the provider may receive and store the data to be summarized from the various subscribers in the data object data store 124. As an illustrative, non-limiting example, the data to be summarized may include call log data and the data object data store 124 may be a call log data store configured to receive and store data that is collected, analyzed or recorded during a telephone call. For example, call log data for a given call may include a call origin, a call destination, a call timestamp, a call length, transmission-related data, an audio recording, and a speech-to-text translation of the audio recording (e.g., a call transcript), among other similar types of data.

The training data store 126 may include a plurality of training datasets curated based on data received or otherwise pulled from the data object data store 124. Each training dataset may be associated with a time, where training datasets may be grouped based on the associated time for use in training or fine-tuning one or more of the models for the LLM architecture 112. Continuing with the call log data example, the training datasets may include at least the call transcripts and associated call timestamps.

The model data store 128 may be configured to store any models, algorithms, or processes to be utilized by one or more components of the data summarization system 108. For example, the model data store 128 may be configured to store at least the pre-trained LLM 114, the first fine-tuned LLM 116 and the second fine-tuned LLM 118.

Although depicted as separate components in FIG. 1, it should be understood that a component or portion of a component in the system of exemplary environment 100 may, in some embodiments, be integrated with or incorporated into one or more other components. For example, the data summarization system 108 or data storage system(s) 110 may be integrated or the like. In some embodiments, operations or aspects of one or more of the components discussed above may be distributed amongst one or more other components. Any suitable arrangement or integration of the various systems and devices of the exemplary environment 100 may be used.

In the following disclosure, various acts may be described as performed or executed by a component from FIG. 1, such as the computing devices 102, one or more of the server-side systems 106, or components thereof. However, it should be understood that in various embodiments, various components of the exemplary environment 100 discussed above may execute instructions or perform acts including the acts discussed below. An act performed by a device may be considered to be performed by a processor, actuator, or the like associated with that device. Further, it should be understood that in various embodiments, various steps may be added, omitted, or rearranged in any suitable manner.

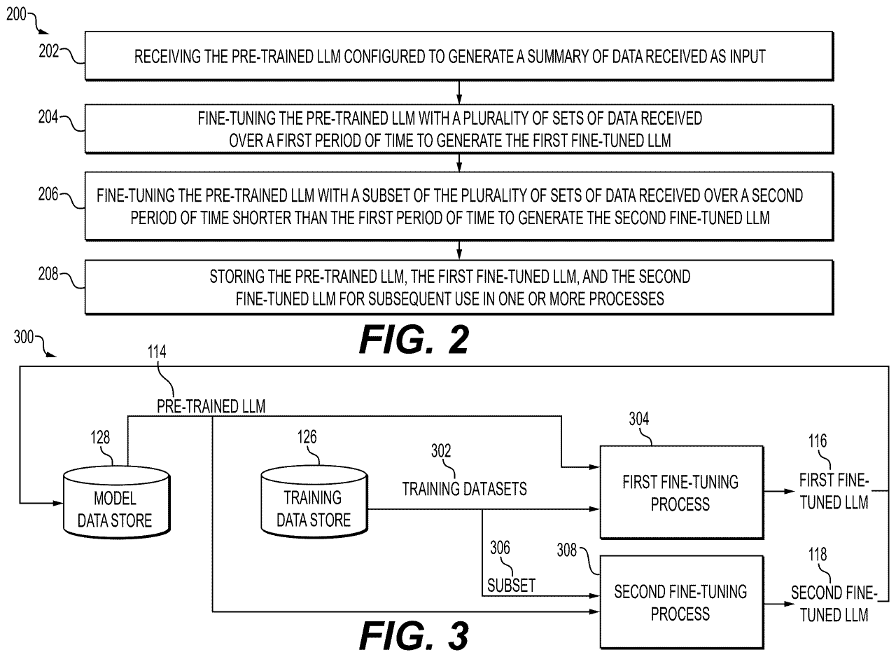

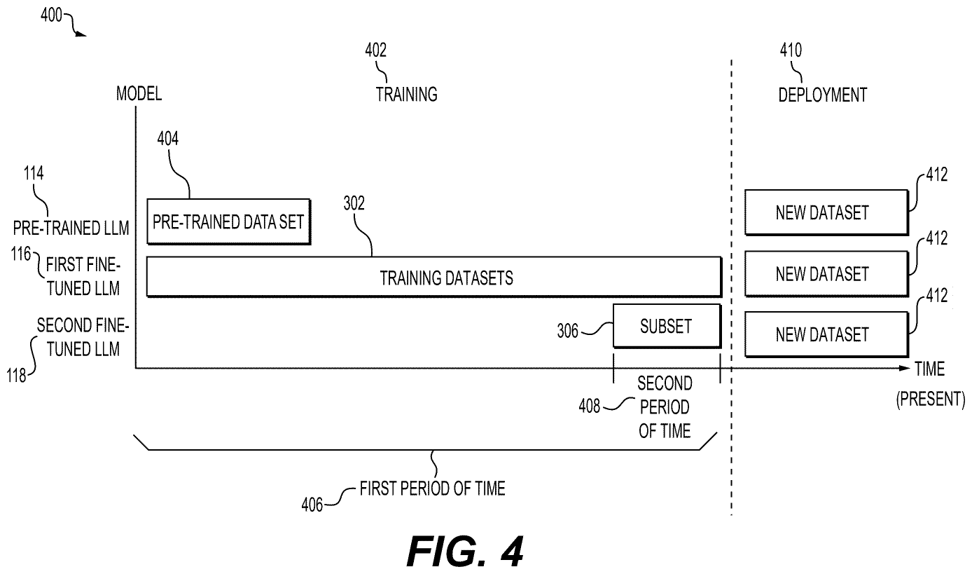

FIG. 2 depicts a flowchart of an exemplary process 200 for building the doubly robust LLM architecture 112, according to certain embodiments. In some examples, the process 200 may be performed by the data summarization system 108. In other examples, the process 200 may be performed by a third party providing model building or maintaining services to the provider. FIG. 3 depicts a block diagram 300 of exemplary fine-tuning processes performed, as part of the process 200, to build the LLM architecture 112. FIG. 4 depicts a conceptual diagram 400 of input data provided to the models of the LLM architecture 112 during training 402 and deployment 410 phases, according to certain embodiments.

Referring concurrently to FIGS. 2-4, at step 202, the process 200 may include receiving the pre-trained LLM 114. The pre-trained LLM 114 may be pre-trained to generate a summary of data received as input. In some examples, the data to be summarized may be call log data. In such examples, the pre-trained LLM 114 may specifically be pre-trained to reconstruct corrupt data included within the call log data. For example, the pre-trained LLM 114 may be configured to identify and adjust for corrupted (e.g., missing or inaccurate) symbols, characters, words or phrases from the call log data when generating the summary. In some examples, the pre-trained LLM 114 may be an off-the-shelf model received from an external data source (e.g., from an open-source library). In other examples, the pre-trained LLM 114 may be internally built and trained by the provider (or the third party providing model building or maintaining services to the provider). The pre-trained LLM 114 may be trained using a pre-trained data set 404.

At step 204, the process 200 may include fine-tuning the pre-trained LLM 114 with a plurality of sets of data (e.g., training datasets 302) received over a first period of time 406 to generate the first fine-tuned LLM 116. For example, as shown in FIG. 3, to perform a first fine-tuning process 304, the pre-trained LLM 114 may be received from the model data store 128, and the training datasets 302 may be received from the training data store 126. The pre-trained LLM 114 may be used as a base model. For example, model parameters of the pre-trained LLM 114 may be copied based on the assumption that the model parameters contain knowledge learned from the pre-trained dataset 404 and this knowledge will also be applicable to first fine-tuned LLM 116. These model parameters are then fine-tuned using the training datasets 302 as they are collected over the first period of time 406 to build or generate the first fine-tuned LLM 116.

Specifically, the first fine-tuned LLM 116 may be a continuously fine-tuned model that receives, as input, batches of the training datasets 302 collected over the first period of time 406 at predetermined intervals. The training datasets 302 may be received or otherwise obtained from internal or external resources.

To provide an illustrative example, the first period of time 406 may include a past five years. Throughout the past five years, subsets or groupings of the training datasets 302 are collected and batched for provision as input to the first fine-tuned LLM 116 at the predetermined intervals (e.g., every month, every quarter, bi-annually, or annually). As shown in FIG. 4, a time frame associated with at least a portion of the training datasets 302 (e.g., the portion being collected early within the first period of time 406) may overlap with a time frame associated with the pre-trained data set 404 upon which the pre-trained LLM 114 was built.

As described herein, the first fine-tuned LLM may be trained (e.g., fine-tuned) by the data summarization system 108. However, in other examples, the first fine-tuned LLM may be trained (e.g., fine-tuned) by the third party, and provided to the data summarization system 108.

At step 206, the process 200 may include fine-tuning the pre-trained LLM 114 with a subset of the plurality of sets of data (e.g. a subset 306 of the training datasets 302) received over a second period of time 408 shorter than the first period of time 406 to generate the second fine-tuned LLM 118. For example, and as shown in FIG. 3, to perform a second fine-tuning process 308, the pre-trained LLM 114 may be received from the model data store 128, and the subset 306 of the training datasets 302 may be received from the training data store 126. The pre-trained LLM 114 may be used as a base model. For example, model parameters of the pre-trained LLM 114 may be copied based on the assumption that the model parameters contain knowledge learned from the pre-trained dataset 404 and this knowledge will also be applicable to the second fine-tuned LLM 118. These model parameters are then fine-tuned using the subset 306 to build or generate the second fine-tuned LLM 118.

Specifically, the second fine-tuned LLM 118 may be fine-tuned by receiving, as input, only one or more recent batches of the training datasets 302 collected. For example, the subset 306 of the training datasets 302 may include only datasets collected over a most recent one or more of the predetermined intervals within the first period of time 406 (e.g., a most recent month, a most recent quarter, a most recent 6 months, most recent year). In other words, and as shown in FIG. 4, the second period of time 408 is a subset of time, and more specifically a more recent subset of time included within the first period of time 406.

As described herein, the second fine-tuned LLM 118 may be trained (e.g., fine-tuned) by the data summarization system 108. However, in other examples, the second fine-tuned LLM 118 may be trained (e.g., fine-tuned) by the third party, and provided to the data summarization system 108.

At step 208, the process 200 may include storing the pre-trained LLM 114, the first fine-tuned LLM 116, and the second fine-tuned LLM 118 for subsequent use in one or more processes. For example, the pre-trained LLM 114, the first fine-tuned LLM 116, and the second fine-tuned LLM 118 may be stored in the model data store 128, and retrieved for execution by the data summarization system 108 to perform data summarization on a new set of data received. For example, and as shown in FIG. 4, during model deployment 410, a new dataset 412 may be provided as input to each to each of the pre-trained LLM 114, the first fine-tuned LLM 116, and the second fine-tuned LLM 118 to generate summaries. In some examples, the new dataset 412 may be a latest batch of data collected at a subsequent predetermined time interval following a completion of the training 402.

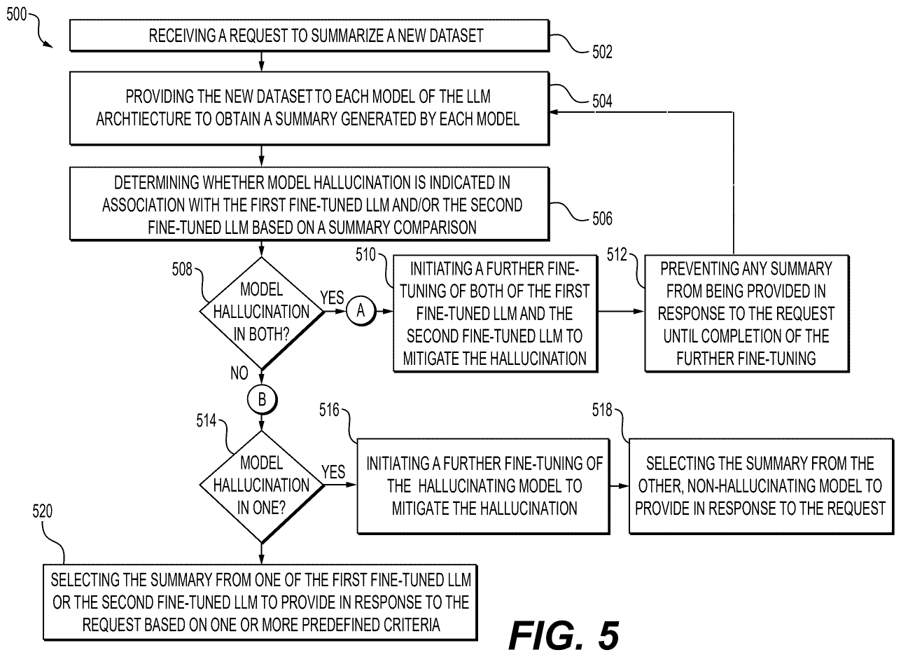

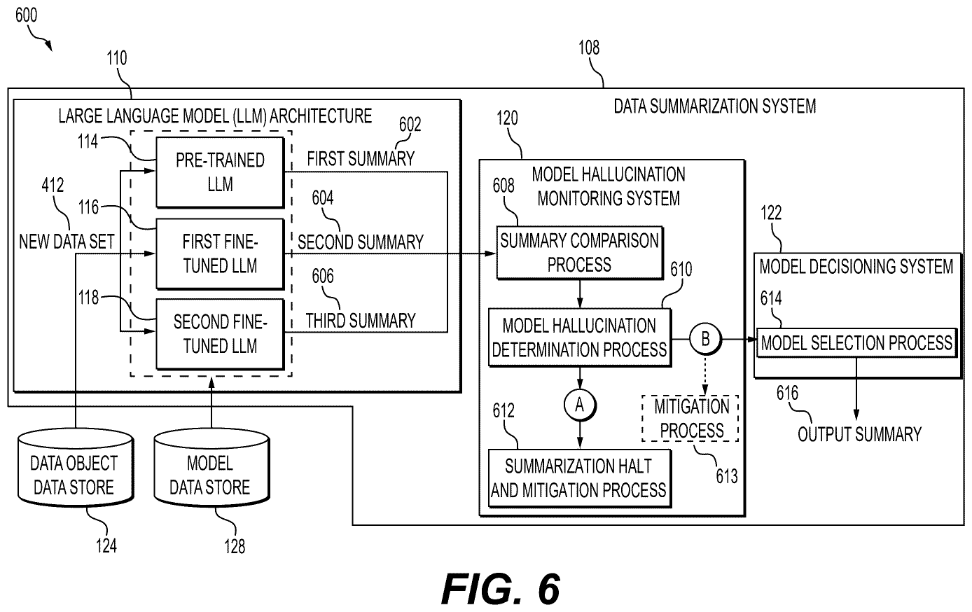

As described in detail with reference to FIGS. 5 and 6, differences between the summaries generated may be identified and used to alert model hallucination, if indicated. Additionally or alternatively, predefined criteria may be applied to select which model's summary is to be provided as an output summary. For example, as a result of the continuous fine-tuning over the longer first period of time 406, the first fine-tuned LLM 116 may be exposed to a large diversity of data topics, whereas the second fine-tuned LLM 118 may be exposed to more narrow, but recently trending data topics (e.g., hot data topics) associated with the shorter second period of time 408. Dependent on the use case, the predefined criteria may indicate which is preferred (e.g., topic diversity v. recency).

Accordingly, certain embodiments may include building the doubly robust LLM architecture 112 for implementation in data summarization processes. The process 200 described above is provided merely as an example, and may include additional, fewer, different, or differently arranged steps than depicted in FIG. 2.

FIG. 5 depicts a flowchart of an exemplary process 500 for data summarization using the doubly robust LLM architecture 112, according to certain embodiments. In some examples, the process 500 may be performed by the data summarization system 108. FIG. 6 depicts a block diagram 600 of exemplary model hallucination monitoring and model decisioning processes performed as part of the data summarization of process 500, according to certain embodiments.

Referring concurrently to FIGS. 5 and 6, at step 502, the process 500 may include receiving a request to summarize a new dataset (e.g., the new dataset 412). In some examples, the request may be a pre-scheduled, automated request received at periodic intervals (e.g., weekly, bi-weekly, monthly, etc.) based on a request schedule that is defined via the application executing on the first computing device 102A (e.g., the subscriber computing device). In other examples, the request may be an ad hoc request received via the application. To provide an illustrative example, the new dataset 412 requested to be summarized may be subscriber call log data (e.g., conversations between customers and agents of the entity subscriber) that was collected over the previous month.

In some examples, and as shown in FIG. 6, in response to receiving the request, the data summarization system 108 may query the data object data store 124 to obtain the new dataset 412 to be summarized. In other examples, the new dataset 412 may be included as part of the request.

At step 504, the process 500 may include providing the new dataset 412 to each model of the LLM architecture 112 to obtain a summary generated by each model. For example, responsive to providing the new dataset 412 as input to each model, a first summary 602 may be generated and output by the pre-trained LLM 114, a second summary 604 may be generated and output by the first fine-tuned LLM 116, and a third summary 606 may be generated and output by the second fine-tuned LLM 118. The first summary 602, the second summary 604, and the third summary 606 may be provided to the model hallucination monitoring system 120.

At step 506, the process 500 may include determining whether model hallucination is indicated in association with the first fine-tuned LLM 116 or the second fine-tuned LLM 118 based on a summary comparison. The summary comparison may use similarity quantification methods. Specifically, the second summary 604 generated and output by the first fine-tuned LLM 116 and the third summary 606 generated and output by the second fine-tuned LLM 118 may each be compared to the first summary 602 generated and output by the pre-trained LLM 114 relative to a similarity threshold. In some examples, the similarity threshold may be a first similarity threshold of a plurality of similarity thresholds applied during the data summarization process. Additionally, the first similarity threshold may be adjustable or otherwise variable based on an associated use case for the data summarization (e.g., based on what downstream processes the data summary may be utilized for).

As part of a summary comparison process 608, text of the first summary 602 may be transformed into a first vector, text of the second summary 604 may be transformed into a second vector, and text of the third summary 606 may be transformed into a third vector. The vectors may be numerical representations of the summaries in a vector space. In some examples, term frequency-inverse document frequency (TF-IDF) vectorization may be applied to transform the text of each of the first summary 602, the second summary 604, and the third summary 606 into the respective first, second, and third vectors. However, in other examples, any type of embedding method may be applied (e.g., frequency of topics, topic modeling, etc.).

The second vector may be compared to the first vector using cosine similarity to determine a first similarity value between the second vector and the first vector indicative of a similarity of the second summary 604 to the first summary 602. For example, a cosine of an angle between the second vector and the first vector in the vector space (e.g., a first cosine similarity value) may be determined as the first similarity value. The smaller the first similarity value, the more similar the second summary 604 is to the first summary 602.

The third vector may be compared to the first vector using cosine similarity to determine a second similarity value between the third vector and the first vector indicative of a similarity of the third summary 606 to the first summary 602. For example, a cosine of an angle between the third vector and the first vector in the vector space (e.g., a second cosine similarity value) may be determined as the second similarity value. The smaller the second similarity value, the more similar the third summary 606 is to the first summary 602.

As part of a model hallucination determination process 610, each of the first similarity value and the second similarity value determined as part of the summary comparison process 608 may be compared to a threshold similarity value associated with the first similarity threshold. Specifically, a first determination may be made as to whether the first similarity value is at or below the threshold similarity value, indicating whether the second summary 604 is similar enough to (or, in other words, is not different enough from) the first summary 602. Similarly, a second determination may be made as to whether the second similarity value is at or below the threshold similarity value, indicating the third summary 606 is similar enough to (or, in other words, is not different enough from) the first summary 602.

Model hallucination associated with the first fine-tuned LLM 116 or the second fine-tuned LLM 118 may be indicated by increased differences in the summaries generated and output by these models from the summaries generated and output by the pre-trained LLM 114. Therefore, the comparison of each of the second summary 604 and the third summary 606 to the first summary 602, as described in detail above, may respectively indicate whether the first fine-tuned LLM 116 and the second fine-tuned LLM 118 are hallucinating or not (e.g., based on whether the first or second similarity values are at or below the threshold similarity value). For example, the first fine-tuned LLM 116 may be hallucinating if the first similarity value is above the threshold similarity value. Similarly, the second fine-tuned LLM 118 may be hallucinating if the second similarity value is above the threshold similarity value. Otherwise, if the first similarity value or second similarity value is at or below the threshold similarity value, then a lack of model hallucination is indicated (e.g., the models are non-hallucinating models).

The process 500 may proceed via either path A or path B dependent on whether model hallucination is indicated based on the determination performed at step 506 (e.g., as part of the model hallucination determination process 610). For example, at a first decision 508, if model hallucination is indicated in association with both the first fine-tuned LLM 116 and the second fine-tuned LLM 118, the process 500 may proceed with path A and step 510.

At step 510, the process 500 may include initiating a further fine-tuning of both of the first fine-tuned LLM 116 and the second fine-tuned LLM to mitigate the hallucination. Due to a likelihood of summary inaccuracy resulting from the model hallucinations, at step 512, the process 500 may include preventing any summary from being provided in response to the request until a completion of the further fine-tuning initiated at step 510. Resultantly, steps 510 and 512 may be collectively referred to as a summarization halt and mitigation process 612 performed by the model hallucination monitoring system 120.

In some examples, a notification may be generated and transmitted to the second computing device 102B associated with the monitoring team member to alert or warn the team member of the hallucination. In some examples, the further fine-tuning may be initiated automatically in response to the first decision 508. In other examples, the further fine-tuning may be initiated manually by the team member responsive to receiving the notification. The further fine-tuning my include providing additional datasets to re-train each of the first fine-tuned LLM 116 and the second fine-tuned LLM 118 to improve the accuracy thereof.

The second fine-tuned LLM 118, being a recent model that is fine-tuned using a smaller subset of more recent datasets, may be fine-tuned more quickly than the first fine-tuned LLM 116. Therefore, once the further fine-tuning of at least the second fine-tuned LLM 118 is completed, the process 500 may return to steps 504 and 506, and an updated third summary of the new dataset 412 generated by the second fine-tuned LLM 118 may be determined to be similar enough to the first summary 602. Based on the similarity, a lack of model hallucination may be indicated in association with at least the second fine-tuned LLM 118, and thus model hallucination is no longer indicated in association with both the first fine-tuned LLM 116 and the second fine-tuned LLM 118 at the first decision 508. Accordingly, the process 500 may then proceed to path B.

Along path B, the process 500 may proceed with a second decision 514 based on the determination at step 506 (e.g., as part of the model hallucination determination process 610). For example, at the second decision 514, if model hallucination is indicated in association with only one of the first fine-tuned LLM 116 and the second fine-tuned LLM 118, the process 500 may proceed with steps 516 and 518.

At step 516, the process 500 may include initiating a further fine-tuning of the hallucinating model to mitigate the hallucination (e.g., via a mitigation process 613). The hallucinating model may be the one of the first fine-tuned LLM 116 or the second fine-tuned LLM with which the model hallucination is indicated in association with based on the determination at step 506. For example, if the first fine-tuned LLM 116 is hallucinating, the first fine-tuned LLM 116 may be fine-tuned. Alternatively, if the second fine-tuned LLM 118 is hallucinating, the second fine-tuned LLM 118 may be fine-tuned. As part of the mitigation process 613, additional datasets may be provided as inputs to the hallucinating model to re-train and improve the accuracy thereof. Due to a likelihood of summary inaccuracy resulting from the model's hallucinations, any summaries generated by the hallucinating model may be prevented from being provided in response to any summary requests received until the further fine-tuning is completed, and the model is no longer hallucinating.

In some examples, a notification may be generated and transmitted to the second computing device 102B associated with the monitoring team member to alert or warn the team member of the hallucination. In some examples, the mitigation process 613 may be initiated automatically in response to the second decision 514. In other examples, the mitigation process 613 may be initiated manually by the team member responsive to receiving the notification.

At step 518, the process 500 may include selecting the summary from the other, non-hallucinating model to provide in response to the request. For example, the model decisioning system 122 may receive an indication of the determination made at step 506 from the model hallucination monitoring system 120 for use in selecting an output summary 616 via the model selection process 614. The hallucinating model or the non-hallucinating model may be indicated to allow selection of the respective summary associated with the non-hallucinating model. For example, if the first fine-tuned LLM 116 is hallucinating and being further fine-tuned, the third summary 606 generated and output by the second fine-tuned LLM 118 may be selected as the output summary 616. Alternatively, if the second fine-tuned LLM 118 is hallucinating and being further fine-tuned, the second summary 604 generated and output by the first fine-tuned LLM 116 is selected as the output summary 616.

However, if, at the second decision 514, neither the first fine-tuned LLM 116 nor the second fine-tuned LLM 118 is indicated as hallucinating (e.g., both models are outputting accurate data summaries), the process 500 may proceed to step 520. At step 520, the process 500 may include selecting the summary from one of the first fine-tuned LLM 116 or the second fine-tuned LLM 118 to provide in response to the request based on one or more predefined criteria.

For example, the model decisioning system 122 may receive an indication of the lack of hallucination determined for either the first fine-tuned LLM 116 or the second fine-tuned LLM from the model hallucination monitoring system 120. In response, the model selection process 614 may compare the second summary 604 and the third summary 606 relative to a second similarity threshold. The second similarity threshold may be different from the first similarity threshold associated with the summary comparison process 608 (e.g., may be a higher or lower threshold similarity value). The second similarity threshold may be adjustable or otherwise variable based on an associated use case for the data summarization (e.g., based on what downstream processes the data summary may be utilized for).

The second vector representing the second summary 604 in the vector space may be compared to the third vector representing the third summary 606 in the vector space using cosine similarity to determine a third similarity value between the second vector and the third vector, indicative of a similarity of the second summary 604 to the third summary 606. For example, a cosine of an angle between the second vector and the third vector in the vector space (e.g., a third cosine similarity value) may be determined as the third similarity value. The smaller the third similarity value, the more similar the second summary 604 is to the third summary 606.

If the second summary 604 and the third summary 606 meet the second similarity threshold (e.g., if the second summary 604 and the third summary 606 are not markedly different from one another), then the first fine-tuned LLM 116 model, being the continuously fine-tuned model exposed to a larger diversity of topics, may be selected. In other words, a diversity associated with the first fine-tuned LLM 116 may be preferred over a recency associated with the second fine-tuned LLM 118 when there are insignificant differences in the summaries generated by each model. Accordingly, the second summary 604 generated and output by the selected first fine-tuned LLM 116 may be provided as the output summary 616 in response to the request.

If the second summary 604 and the third summary 606 do not meet the second similarity threshold (e.g., if the second summary 604 and the third summary 606 are markedly different from one another), which model is selected may be dependent on the predefined criteria. For example, if a predefined criterion indicates the diversity associated with the first fine-tuned LLM 116 is always preferred (e.g., even when the second similarity threshold is not met), the first fine-tuned LLM 116 may be selected. Accordingly, the second summary 604 generated and output by the selected first fine-tuned LLM 116 may be provided as the output summary 616 in response to the request. Alternatively, if a predefined criterion indicating the recency associated with the second fine-tuned LLM 118 is preferred when the second similarity threshold is not met, then the second fine-tuned LLM 118 may be selected. Accordingly, the third summary 606 generated and output by the selected second fine-tuned LLM 118 may be provided as the output summary 616 in response to the request. The preference of the second fine-tuned LLM 118 in such circumstances may be based on an assumption that the first fine-tuned LLM 116 is degrading more quickly than the first fine-tuned LLM 116, and thus second fine-tuned LLM 118 may be more accurate.

The output summary 616 may be provided to the first computing device 102A associated with the subscriber (e.g., via the application). In some examples, the output summary 616 may be provided as input into one or more downstream processes performed by the provider or other service providers engaged by the subscriber. Continuing the illustrative example where the output summary 616 of the new dataset 412 is a summary of the subscriber call log data that was collected over the previous month, the summary may be provided as input to a sentiment analysis process or other similar analysis from which insights regarding the market, competition, or general customer sentiment may be derived.

The process 500 described herein implements the doubly robust LLM architecture 112 to identify, via summary comparison techniques, model hallucination for mitigation, resulting in hallucination-resistant data summarization. Similar comparison techniques may be applied to indicate or otherwise alert to other types of model degradation that may be affecting a quality or accuracy of the output generated by the model(s). Additionally, the implementation of the doubly robust LLM architecture 112 may provide for flexible model selection to account for a wide variety of use cases, where in some instances diversity is preferred, and in other instances recency is preferred.

Accordingly, certain embodiments may include data summarization processes. The process 500 described above is provided merely as an example, and may include additional, fewer, different, or differently arranged steps than depicted in FIG. 5.

In general, any process or operation discussed in this disclosure that is understood to be computer-implementable, such as the processes or operations depicted in FIGS. 2-6, may be performed by one or more processors of a computer system, such any of the systems or devices in the environment 100 of FIG. 1, as described above. A process or process step performed by one or more processors may also be referred to as an operation. The one or more processors may be configured to perform such processes by having access to instructions (e.g., software or computer-readable code) that, when executed by the one or more processors, cause the one or more processors to perform the processes. The instructions may be stored in a memory of the computer system. A processor may be a central processing unit (CPU), a graphics processing unit (GPU), or any suitable type of processing unit.

A computer system, such as a system or device implementing a process or operation in the examples above, may include one or more computing devices, such as one or more of the systems or devices in FIG. 1. One or more processors of a computer system may be included in a single computing device or distributed among a plurality of computing devices. A memory of the computer system may include the respective memory of each computing device of the plurality of computing devices.

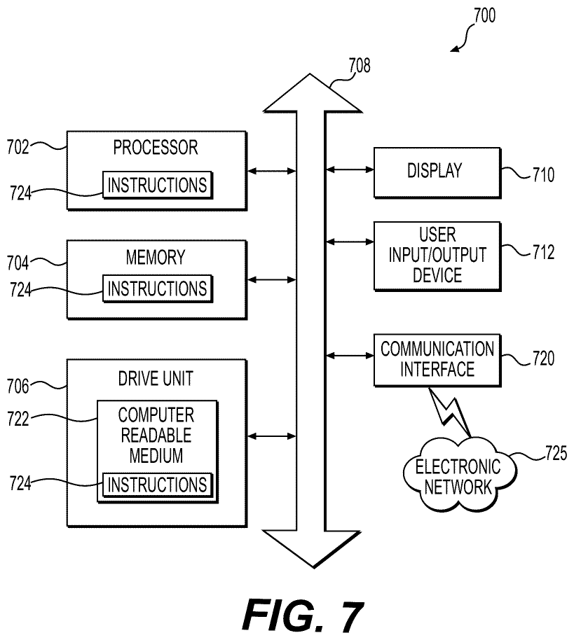

FIG. 7 depicts an example of a computer 700, according to certain embodiments. FIG. 7 is a simplified functional block diagram of a computer 700 that may be configured as a device for executing processes or operations depicted in, or described with respect to, FIGS. 2-6, according to exemplary embodiments of the present disclosure. For example, the computer 700 may be configured as one of the computing devices 102, one of the server-side systems 106, or another device according to exemplary embodiments of this disclosure. In various embodiments, any of the systems herein may be a computer 700 including, e.g., a data communication interface 720 for packet data communication. The computer 700 may communicate with one or more other computers 700 using the electronic network 725. The electronic network 725 may include a wired or wireless network similar to the network 104 depicted in FIG. 1.

The computer 700 also may include a central processing unit (“CPU”), in the form of one or more processors 702, for executing program instructions 724. The program instructions 724 may include instructions for running the application (e.g., if the computer 700 is one of the computing devices 102). The program instructions 724 may include instructions for running one or more operation of the server-side systems 106 (e.g., if the computer 700 is a server device or other similar computing device of one or more of the respective server-side systems 106). The computer 700 may include an internal communication bus 708, and a drive unit 706 (such as read-only memory (ROM), hard disk drive (HDD), solid-state disk drive (SDD), etc.) that may store data on a computer readable medium 722, although the computer 700 may receive programming and data via network communications. The computer 700 may also have a memory 704 (such as random access memory (RAM)) storing instructions 724 for executing techniques presented herein, although the instructions 724 may be stored temporarily or permanently within other modules of computer 700 (e.g., processor 702 or computer readable medium 722). The computer 700 also may include user input and output ports 712 or a display 710 to connect with input and output devices such as keyboards, mice, touchscreens, monitors, displays, etc. The various system functions may be implemented in a distributed fashion on a number of similar platforms, to distribute the processing load. Alternatively, the systems may be implemented by appropriate programming of one computer hardware platform.

Program aspects of the technology may be thought of as “products” or “articles of manufacture” typically in the form of executable code or associated data that is carried on or embodied in a type of machine-readable medium. “Storage” type media include any or all of the tangible memory of the computers, processors or the like, or associated modules thereof, such as various semiconductor memories, tape drives, disk drives and the like, which may provide non-transitory storage at any time for the software programming. All or portions of the software may at times be communicated through the Internet or various other telecommunication networks. Such communications, e.g., may enable loading of the software from one computer or processor into another. Thus, another type of media that may bear the software elements includes optical, electrical and electromagnetic waves, such as used across physical interfaces between local devices, through wired and optical landline networks and over various air-links. The physical elements that carry such waves, such as wired or wireless links, optical links, or the like, also may be considered as media bearing the software. As used herein, unless restricted to non-transitory, tangible “storage” media, terms such as computer or machine “readable medium” refer to any medium that participates in providing instructions to a processor for execution.

While the disclosed methods, devices, and systems are described with exemplary reference to transmitting data, it should be appreciated that the disclosed embodiments may be applicable to any environment, such as a desktop or laptop computer, an automobile entertainment system, a home entertainment system, etc. Also, the disclosed embodiments may be applicable to any type of Internet protocol.

It should be understood that embodiments in this disclosure are exemplary only, and that other embodiments may include various combinations of features from other embodiments, as well as additional or fewer features. For example, while some of the embodiments above pertain to training, fine-tuning, or using one or more LLMs for summarizing data, such as call log data, any suitable activity may be used.

It should be appreciated that in the above description of exemplary embodiments of the invention, various features of the invention are sometimes grouped together in a single embodiment, figure, or description thereof for the purpose of streamlining the disclosure and aiding in the understanding of one or more of the various inventive aspects. This method of disclosure, however, is not to be interpreted as reflecting an intention that the claimed invention requires more features than are expressly recited in each claim. Rather, as the following claims reflect, inventive aspects lie in less than all features of a single foregoing disclosed embodiment. Thus, the claims following the Detailed Description are hereby expressly incorporated into this Detailed Description, with each claim standing on its own as a separate embodiment of this invention.

Furthermore, while some embodiments described herein include some but not other features included in other embodiments, combinations of features of different embodiments are meant to be within the scope of the invention, and form different embodiments, as would be understood by those skilled in the art. For example, in the following claims, any of the claimed embodiments can be used in any combination.

Thus, while certain embodiments have been described, those skilled in the art will recognize that other and further modifications may be made thereto without departing from the spirit of the invention, and it is intended to claim all such changes and modifications as falling within the scope of the invention. For example, functionality may be added or deleted from the block diagrams and operations may be interchanged among functional blocks. Steps may be added or deleted to methods described within the scope of the present invention.

The above disclosed subject matter is to be considered illustrative, and not restrictive, and the appended claims are intended to cover all such modifications, enhancements, and other implementations, which fall within the true spirit and scope of the present disclosure. Thus, to the maximum extent allowed by law, the scope of the present disclosure is to be determined by the broadest permissible interpretation of the following claims and their equivalents, and shall not be restricted or limited by the foregoing detailed description. While various implementations of the disclosure have been described, it will be apparent to those of ordinary skill in the art that many more implementations are possible within the scope of the disclosure. Accordingly, the disclosure is not to be restricted except in light of the attached claims and their equivalents.

What is claimed is:

1. A system for data summarization, the system comprising:
a pre-trained large language model (LLM) configured to generate a summary of data received as input;
a first fine-tuned LLM derived from the pre-trained LLM and fine-tuned with a plurality of sets of data received over a first period of time;
a second fine-tuned LLM derived from the pre-trained LLM and fine-tuned with a subset of the plurality of sets of data received over a second period of time shorter than the first period of time; and
a computing system comprising:
at least one memory storing instructions; and
at least one processor operatively connected to the at least one memory and configured to execute the instructions to perform operations, including:
receiving a request to summarize a new set of data;
providing the new set of data, as input, to each of the pre-trained LLM, the first fine-tuned LLM, and the second fine-tuned LLM to obtain, as output, a first summary of the new set of data generated by the pre-trained LLM, a second summary of the new set of data generated by the first fine-tuned LLM, and a third summary of the new set of data generated by the second fine-tuned LLM;
comparing each of the second summary and the third summary to the first summary relative to a similarity threshold;
when, based on the comparing, a similarity between the first summary and each of the second summary and the third summary meet the similarity threshold, selecting one of the second summary or the third summary to provide as a response to the request based on one or more predefined criteria; and
when, based on the comparing, a similarity between the first summary and at least one of the second summary or the third summary fails to meet the similarity threshold, the failure being indicative of a hallucination associated with the at least one of the first fine-tuned LLM or the second fine-tuned LLM, respectively, initiating a further fine-tuning of the at least one of the first fine-tuned LLM or the second fine-tuned LLM to mitigate the hallucination.

2. The system of claim 1, wherein when the similarity between the first summary and at least one of the second summary or the third summary fails to meet the similarity threshold, the operations further include:
preventing the at least one of the first fine-tuned LLM or the second fine-tuned LLM from generating any summaries responsive to requests until the further fine-tuning is completed.

3. The system of claim 1, wherein, when the similarity between the first summary and only one of the second summary or the third summary fails to meet the similarity threshold, the operations further include:
providing an other of the second summary or the third summary that meets the similarity threshold as the response to the request.

4. The system of claim 1, wherein the similarity threshold is a first similarity threshold, and selecting one of the second summary or the third summary to provide as the response to the request based on one or more predefined criteria includes:
comparing the second summary and the third summary relative to a second similarity threshold;
determining a similarity between the second summary and the third summary fails to meet the second similarity threshold; and
selecting the second summary to provide as the response to the request based on a predefined criterion indicating a diversity associated with the first fine-tuned LLM is preferred when the second similarity threshold is not met.

5. The system of claim 1, wherein the similarity threshold is a first similarity threshold, and selecting one of the second summary or the third summary to provide as the response to the request based on one or more predefined criteria includes:
comparing the second summary and the third summary relative to a second similarity threshold;
determining a similarity between the second summary and the third summary fails to meet the second similarity threshold; and
selecting the third summary to provide as the response to the request based on a predefined criterion indicating a recency associated with the second fine-tuned LLM is preferred when the second similarity threshold is not met.

6. The system of claim 1, wherein comparing each of the second summary and the third summary to the first summary relative to the similarity threshold includes:
transforming text of the first summary into a first vector, text of the second summary into a second vector, and text of the third summary into a third vector;
determining a first similarity value between the second vector and the first vector;
determining a second similarity value between the third vector and the first vector; and
comparing each of the first similarity value and the second similarity value to a threshold similarity value associated with the similarity threshold.

7. The system of claim 6, further comprising:
applying term frequency-inverse document frequency (TF-IDF) vectorization to transform the text; and
using cosine similarity to determine the first similarity value and the second similarity value.

8. The system of claim 1, wherein the first fine-tuned LLM is configured to receive the plurality of sets of data over the first period of time at predetermined intervals, and the subset of the plurality of sets of data is a subset received at a most recent of the predetermined intervals.

9. The system of claim 1, wherein the subset of the plurality of sets of data is a first subset representing a most recent subset of the plurality of sets of data, and the pre-trained LLM is generated based on a second subset representing an earliest subset of the plurality of sets of data received over the first period of time.

10. The system of claim 1, wherein, when the similarity between the first summary and at least one of the second summary or the third summary fails to meet the similarity threshold, the operations further include:
generating and transmitting a notification to indicate the hallucination associated with the at least one of the first fine-tuned LLM or the second fine-tuned LLM.

11. The system of claim 1, wherein the data is call log data.

12. A method, performed by a computing system, for data summarization, the method comprising:
receiving a request to summarize a dataset;
providing the dataset, as input, to each model of a large language model (LLM) architecture executed by the computing system, the LLM architecture including:
a pre-trained LLM configured to generate a summary of input data,
a first fine-tuned LLM derived from the pre-trained LLM and fine-tuned with a plurality of training datasets received over a first period of time, and
a second fine-tuned LLM derived from the pre-trained LLM and fine-tuned with a subset of the plurality of training datasets received over a second period of time shorter than the first period of time;
receiving, as output, a summary of the dataset from each model of the LLM architecture, including a first summary generated by the pre-trained LLM, a second summary generated by the first fine-tuned LLM, and a third summary generated by the second fine-tuned LLM;
comparing each of the second summary and the third summary to the first summary relative to a first similarity threshold;
determining that a similarity of each of the second summary and the third summary to the first summary meets the first similarity threshold, the meeting of the first similarity threshold being indicative of a lack of hallucination associated with the first fine-tuned LLM and the second fine-tuned LLM;
comparing the second summary to the third summary relative to a second similarity threshold; and
selecting one of the second summary or the third summary to provide as a response to the request based on the comparing and one or more predefined criteria.

13. The method of claim 12, wherein the selecting comprises:
determining, based on the comparing, a similarity between the second summary and the third summary fails to meet the second similarity threshold; and
selecting the second summary to provide as the response to the request based on a predefined criterion indicating a diversity associated with the first fine-tuned LLM is preferred when the second similarity threshold is not met.

14. The method of claim 12, wherein the selecting comprises:
determining, based on the comparing, a similarity between the second summary and the third summary fails to meet the second similarity threshold; and
selecting the third summary to provide as the response to the request based on a predefined criterion indicating a recency associated with the second fine-tuned LLM is preferred when the second similarity threshold is not met.

15. The method of claim 12, wherein comparing each of the second summary and the third summary to the first summary relative to the first similarity threshold comprises:
transforming text of the first summary into a first vector, text of the second summary into a second vector, and text of the third summary into a third vector;
determining a first similarity value between the second vector and the first vector;
determining a second similarity value between the third vector and the first vector; and
comparing each of the first similarity value and the second similarity value to a first threshold similarity value associated with the first similarity threshold.

16. The method of claim 15, wherein comparing the second summary to the third summary relative to a second similarity threshold comprises:
determining whether a difference between the first similarity value and the second similarity value exceeds a value associated with the second similarity threshold.

17. The method of claim 12, wherein the plurality of training datasets are received over the first period of time at predetermined intervals, and wherein the subset of the plurality of training datasets are received at a most recent of the predetermined intervals.

18. A method, performed by a computing system, for data summarization, the method comprising:
receiving a request to summarize a dataset;
providing the dataset, as input, to each model of a large language model (LLM) architecture executed by the computing system, the LLM architecture including:
a pre-trained LLM configured to generate a summary of input data,
a first fine-tuned LLM derived from the pre-trained LLM and fine-tuned with a plurality of training datasets received over a first period of time, and
a second fine-tuned LLM derived from the pre-trained LLM and fine-tuned with a subset of the plurality of training datasets received over a second period of time shorter than the first period of time;
receiving, as output, a summary of the dataset from each model of the LLM architecture, including a first summary generated by the pre-trained LLM, a second summary generated by the first fine-tuned LLM, and a third summary generated by the second fine-tuned LLM;
comparing each of the second summary and the third summary to the first summary relative to a first similarity threshold;
determining, based on the comparing, that a similarity between the first summary and at least one of the second summary or the third summary fails to meet a similarity threshold indicative of a hallucination associated with the at least one of the first fine-tuned LLM or the second fine-tuned LLM, respectively; and
initiating a further fine-tuning of the at least one of the first fine-tuned LLM or the second fine-tuned LLM to mitigate the hallucination.

19. The method of claim 18, further comprising:
preventing the at least one of the first fine-tuned LLM or the second fine-tuned LLM from generating any summaries responsive to requests until the further fine-tuning is completed.

20. The method of claim 18, wherein, the similarity between the first summary and only one of the second summary or the third summary fails to meet the similarity threshold, and the method further comprises:
providing an other of the second summary or the third summary that meets the similarity threshold as a response to the request.
